(19) United States
(12) Patent Application Publication
(10) Pub. No.: US 2018/0228014 A1
(43) Pub. Date: Aug. 9, 2018

(54) CONTROL OF POWER SUPPLIED TO A PLASMA TORCH TO COMPENSATE FOR CHANGES AT AN ELECTRODE

(71) Applicant: Edwards Limited, Burgess Hill, West Sussex (GB)

(72) Inventors: Simone Magni, Clevedon (GB); Jerome Boegner, Clevedon (GB); MinKyeong Noh, Cheonan-si (KR); JiYoung Son, Cheonan-si (KR); JinOk Lee, Cheonan-si (KR)

(21) Appl. No.: 15/750,010

(22) PCT Filed: Jul. 26, 2016
(86) PCT No.: PCT/GB2016/052282

§ 371 Date: Feb. 2, 2018

(30) Foreign Application Priority Data
Aug. 4, 2015 (GB) 1513779.7

(51) Int. Cl. H05H 1/36; G05B 19/04; B23K 10/00

(52) U.S. Cl. CPC H05H 1/36; B23K 10/006; G05B 19/041

(57) ABSTRACT

A power supply configured to supply power to a plasma torch in a gas treatment system within a predetermined power limit by periodically receiving at least one input signal indicative of a current power output by the power supply; and in response to the at least one input signal indicating the power output has passed a predetermined value adjusting the power output such that the power output is within the predetermined power limit. Adjusting the power output includes: outputting a control signal to change a flow rate of a source gas supplied to the plasma torch where the change would maintain a source gas flow rate within predetermined gas flow limits; and where the change would not maintain the source gas flow rate within the predetermined gas flow limits, outputting a control signal to change one of a current or voltage output by the power supply unit.

### CROSS-REFERENCE OF RELATED APPLICATION

This application is a Section 371 National Stage Application of International Application No, PCT/GB2016/052282, filed Jul. 26, 2016, which is incorporated by reference in its entirety and published as WO 2017/021694 A1 on Feb. 9, 2017 and which claims priority of British Application No. 1513779.7, filed Aug. 4, 2015.

### FIELD

The field of the embodiments relate to the control of the power output by a power supply configured to supply electrical energy to a plasma torch for treating a gas stream. The embodiments also relate to an apparatus for treating the gas stream.

### BACKGROUND

Plasmas can be generated to treat an effluent gas stream from a manufacturing process used in, for example, the semiconductor or flat panel display manufacturing industry. During such manufacturing, residual fluorinated or perfluorinated compounds (PFCs) and other compounds exist in the effluent gas stream pumped from the process tool. These compounds are difficult to remove from the effluent gas stream and their release into the environment is undesirable because they are known to have relatively high greenhouse activity and in some cases can be toxic.

Plasmas for abatement devices can be formed in a variety of ways. Microwave plasma abatement devices can be connected to the exhaust of several process chambers. Each device requires its own microwave generator, which can add considerable cost to a system. Plasma torch abatement devices are advantageous over microwave plasma abatement devices in terms of scalability and in dealing with powder (present in the effluent stream or generated by the abatement reactions).

Plasma torches require a high electrical field to be applied between an anode and cathode between which a source gas flows in order to initiate a breakdown discharge. If enough current between the anode and cathode is provided, the ionisation of the source gas is sustained and a plasma plume (or flare) is formed at the anode exit. The effluent gas stream is mixed with the plasma plume and the undesirable compounds are broken down. Plasma torches can consume considerable power and the high electrical field or high electrical current can damage both the cathode and the anode. Control of the power supplied to the plasma torch is not straightforward as increases in the current through the plasma causing the voltage to fall.

WO2013/024248 discloses a plasma torch for use in an abatement device for treating the output of a chemical vapour deposition process. It recognises that the control of power supplied to such a plasma torch has conventionally been difficult to manage and as such plasma torches have generally operated at a constant power. It also recognises that in some situations where a process outputs different gases at different times, then these gases may require different amounts of electrical power to be supplied to the torch for effective treatment. This is due to the fact that some compounds are more stable than others requiring a higher power to break them down. It addresses this problem by varying the amount of source gas and electrical current supplied to the plasma flare which in turn varies the power of operation of the plasma torch allowing the torch to be used for the treatment of different gases.

JP2006202605 discloses a method of controlling a current supplied to a plasma torch during a start up phase of the torch and then during operation in dependence upon a temperature of some components in the vicinity of the plasma plume.

The supply of power to plasma torches can be problematic due to their high power consumption and due to variations in power consumption arising due to anode erosion and powder deposition. Accordingly, it is desired to provide an improved technique for controlling the power supplied to a plasma torch and for processing an effluent gas stream.

The discussion above is merely provided for general background information and is not intended to be used as an aid in determining the scope of the claimed subject matter. The claimed subject matter is not limited to implementations that solve any or all disadvantages noted in the background.

### SUMMARY

According to a first aspect there is provided a method of maintaining power output by a power supply configured to supply power to a plasma torch in a gas treatment system within a predetermined power limit, said method comprising: periodically receiving at least one input signal indicative of a current power output by said power supply; in response to said at least one input signal indicating said power output has passed a predetermined value adjusting said power output such that said power output is within said predetermined power limit; said step of adjusting said power output comprising: outputting a control signal to change a flow rate of a source gas supplied to said plasma torch where said change would maintain a source gas flow rate within predetermined gas flow limits; and where said change would not maintain said source gas flow rate within said predetermined gas flow limits, outputting a control signal to change one of a current or voltage output by said power supply unit.

Plasma torches require a high electrical field between a cathode and an anode to trigger electrical discharge between them through a source gas which is ionised by the electrical discharge and forms a plasma plume. The power required to sustain this electrical discharge is high especially at atmospheric pressure. Over time the anode may become damaged and/or corroded and/or powder deposits may form on the anode, all of which change the properties of the electrodes and can result in a change in the amount of power consumed to maintain the plasma plume. Significant changes in the power consumed by a plasma torch over time are undesirable for an operator and therefore it may be advantageous to try to maintain the power consumed within predetermined limits.

The inventors recognised, that over time the power consumed by the power supply of a plasma torch may vary due to changes in the electrodes and in order to compensate for these variations some form of power control would be desirable. However, varying the power supplied to a plasma torch has its own issues. Firstly, varying the power by varying current or voltage is not as effective as one might expect as increases in for example, the current supplied to the torch leads to reductions in the voltage, thus reducing the effect it has on the power output. A further way of varying the power can be achieved by varying the rate of flow of plasma source gas. This is an effective way of controlling the power but care must be taken that the source gas flow rate is maintained within limits that allow a plasma plume and its DRE (destruction or removal efficiency) to be effectively maintained. Thus, the present application addresses the problem of changes in the power consumption of a plasma torch by monitoring this power consumption and where it moves outside of a limit value, seeking to adjust the power by, in the first instance, adjusting the rate of flow of the source gas, but only where this can be done with the source gas flow rate being maintained within acceptable limits. Where such an adjustment would take the rate of flow of source gas outside of predetermined limits the power is adjusted by adjusting one of the voltage or current output by the power supply. Thus, power control using two possible control mechanisms is provided, the mechanism being selected depending on current conditions.

In some embodiments, said power supply is configured to output a current and a voltage, one of said current and said voltage being output at a predetermined substantially constant value and the other of said current and voltage providing said at least one input signal; and wherein said step of outputting said control signal to change said at least one of a current or voltage output by said power supply unit comprises outputting a control signal to change said predetermined substantially constant value to a different predetermined substantially constant value.

The power supply may supply power by supplying a constant voltage or constant current and changes in the anode will cause changes in the other one of the current and voltage that is not held substantially constant to vary. Thus, monitoring these variations will provide an indication of variations in the power output by the power supply. When it is desired to change the power output by the power supply and where this cannot be achieved by changes in the flow of source gas as this is at a limit value, then a change in the predetermined substantial constant value to a different predetermined substantially constant value is used to provide a change in output power.

In some embodiments, said power supply is configured to supply a predetermined substantially constant DC current and said at least one input signal comprises a voltage output by said power supply.

Although the plasma torch may be supplied by either a DC or AC power supply it may be advantageous to have a DC power supply. A DC power supply has the advantage of not requiring load matching with the device it is supplying. When AC power is supplied then where the load of the power supply is not matched to the powered device reflections occur generating inefficiencies. There may however be some advantages of an AC power supply and in particular the oscillatory nature of the ions in the AC field may reduce wear due to sputtering of electrons when compared to a similar power supplied by a DC field.

Varying the rate of flow of source gas supplied to the plasma torch will vary the resistance and where current is maintained constant the power supplied will also vary in a predictable manner. Thus, in the first instance variations in the power output can be compensated for by varying the rate of flow of source gas. Further control of the power supplied can be attained by controlling the predetermined value of the constant current that is supplied to the plasma torch. Such control may be required where the properties of the plasma torch have changed over time, such that keeping the power within required limits is not possible by simply varying the source gas flow and a different constant current is required.

In some embodiments, said power supply comprises an AC power supply and said power supply is configured to output a predetermined substantially constant root mean square voltage value.

As noted above, an AC power supply can also be used and in some cases this may supply a substantially constant root mean square voltage value. Clearly an AC power supply will not supply a constant voltage, but it can supply a root mean square constant value, variations in the power supply being indicated by variations in the root mean square value of the current output by the power supply.

In some embodiments, said predetermined power limit comprises an upper power limit for said power supply, and in response to said at least one input signal indicating that said current power output is greater than a predetermined value, reducing said flow rate of said source gas where said flow rate is greater than a predetermined minimum value, and where not reducing said predetermined substantially constant value.

As noted previously, where the power limit is passed then in the first instance, a change in flowrate of the source gas can be used to change the output power. However, this can only be done where such a change in flowrate does not bring the rate of flow outside of limit values. In this case, where the maximum predetermined power limit is exceeded, then the flowrate can be reduced provided that the flowrate is not reduced below a minimum value that is sufficient to generate a plasma plume. If the source gas drops too low, then the plasma plume may be quenched and the plasma torch will no longer provide the plasma required for abating the gas. Thus, where the required change in the flowrate would bring it below a minimum value, the substantially constant value output by the power supply can be reduced instead. Thus, in the case of a substantially constant current power supply, the level of the current supplied will be reduced and in the case of a substantially constant voltage power supply, then the level of the voltage supplied will be reduced. As noted previously, where the power supply is an AC power supply, then the substantially constant value that is reduced will be a substantially constant root mean square value.

In some embodiments, said predetermined power limit comprises a lower power limit for said power supply, and in response to said at least one input signal indicating that said current power output is less than said predetermined value, increasing said flow rate of said source gas where said flow rate is less than a predetermined maximum value and where not, increasing said predetermined substantially constant value.

Where the power limit is a lower power limit and where the current power output drops below this lower limit, then the flowrate of the source gas can be increased to increase the power output provided that it is not increased above a predetermined maximum value. In many instances the power limit falling may be due to powder deposition on the anode and as such increasing the source gas flow rate may have the additional advantage of helping clear at least some of the powder.

Where the required change in power would change the flowrate above the maximum allowed value, then the output of the power supply may be changed by increasing the predetermined substantially constant value that is being output. Thus, in a case of a constant current power supply it will be the value of the current that is increased, while in the case of a substantially constant voltage power supply, it will be the value of the voltage that is output that is increased.

In some embodiments, the method comprises maintaining said power output by said power supply within a predetermined range, said method comprising in response to said at least one input signal indicating said power output has passed one of an upper or a lower predetermined value, adjusting said power output such that said power output is within said predetermined power range.

In many cases, the power supply may be required to be maintained within a predetermined range. In this regard, variations in the power output by the power supply may cause the power output to rise or to fall depending on the cause of the variations. Thus, anode erosion causes the power output to rise while powder deposition may cause it to fall. In some cases where only one of these phenomena is a problem, then the power limit that is monitored may be simply the upper or the lower power limit. However where both conditions may arise, it may be important to maintain the power within a predetermined range, such that both an upper and a lower predetermined value are monitored and the power output is adjusted accordingly. The adjustment of the power output can be made by using the rate of flow of source gas or by varying the substantially constant value as set out above.

In some embodiments, the method comprises a further step of in response to outputting said control signal to change said predetermined substantially constant value to beyond a predetermined limit value generating and outputting an anode inspection signal.

As noted previously, in the first instance it is advantageous if the power output can be varied by varying the rate of flow of plasma source gas. When the rate of flow of plasma source gas reaches limit values, then the substantially constant value output by the power supply may need to be varied to maintain the power at a required level. However, variations in this level are indications of changes to the plasma torch and as such they may be used to provide an indication to the user of the plasma torch that the anode may need to be inspected. Thus, it may be advantageous to generate an anode inspection warning signal when the predetermined substantially constant value goes beyond a predetermined limit value. This limit value can be selected in dependence upon the particular plasma torch and/or the requirements of the operator.

In some embodiments, the method comprises a further step of receiving a signal indicative of a current flow rate of a source gas supplied to said plasma torch; and said step of adjusting said power comprises: determining a required change in said source gas flow rate; determining whether said required change to said source gas flow rate would bring said source gas flow rate outside of said predetermined gas flow rate limits; and where not outputting a control signal to a source gas flow regulator to make said required change; and where so outputting a control signal to change said substantially predetermined value.

As noted previously, in the first instance it may be desirable to change the power output to the power torch by changing the rate of flow of source gas. However, the rate of flow of source gas does need to be maintained within certain limits and thus, prior to performing this change it may be advantageous to determine the change in source gas flow rate required to generate the required change in power and where this take the source gas flow rate outside of predetermined limits, then a control signal to change the substantially predetermined value can be generated and output as opposed to one to change a source gas flow regulator.

A second aspect of the present invention provides a computer program which when executed by a processor is operable to control said processor to perform steps according to a first aspect of the present invention.

A third aspect of the present invention provides a controller for maintaining a power output by a power supply, configured to supply power to a plasma torch in a gas treatment system, within a predetermined power limit, said controller comprising: an input configured to receive at least one input signal indicative of a current power output by said power supply; logic configured to generate a control signal for controlling said output of said power supply, said logic being operable in response to said at least one input signal indicating said power output has passed a predetermined value to adjust said power output such that said power output is within said predetermined power limit, by: generating a control signal to change a flow rate of a source gas supplied to said plasma torch rate where said change provides a source gas flow rate within predetermined gas flow limits; and where not generating a control signal to change one of a current or voltage output by said power supply unit; and an output for outputting said control signals.

In some embodiments, said logic comprises programmable control logic comprising a computer program according to a second aspect of the present invention.

A fourth aspect of the present invention provides an apparatus for treating a gas stream comprising: a plasma torch for generating a plasma plume from a source gas when energised by electrical energy; a power supply for supplying said electrical energy to said plasma torch; a flow rate regulator for regulating a rate of flow of said plasma source gas to said plasma torch; and a controller according to a second aspect of the present invention, for controlling said power output by said power supply.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

The Summary is provided to introduce a selection of concepts in a simplified form that are further described in the Detail Description. This summary is not intended to identify key features or essential features of the claimed subject matter, nor is it intended to be used as an aid in determining the scope of the claimed subject matter.

### BRIEF DESCRIPTION OF THE DRAWINGS

The embodiments will now be described further, with reference to the accompanying drawings, in which:

FIG. 1 shows a plasma torch for use in the treatment of gas according to an embodiment;

FIG. 2 schematically shows an abatement system according to an embodiment;

FIGS. 3A and 3B show how voltage and current of the power supply unit supplying power to the plasma torch change with source gas flow rate;

FIG. 4 schematically shows the input and output signals of a control system according to an embodiment;

FIG. 5 shows a proportional flow tube flow regulator for regulating a source gas for use in an embodiment; and

FIG. 6 shows a flow diagram illustrating steps performed to achieve a fixed regulated power in the presence of voltage variation due to anode erosion and powder deposition.

### DETAILED DESCRIPTION

Before discussing the embodiments in any more detail, first an overview will be provided.

Embodiments recognise that plasma torches' power consumption can change significantly over time due to changes at the electrodes. This can lead to problems if it is not controlled. Embodiments seek to maintain the power consumption of a plasma torch within limits, to reduce such difficulties. Thus, a power control option is provided which in the first instance controls the power by adjusting the rate of flow of the plasma source gas and when operational limits for such flow rates approach then the torch voltage and/or current is adjusted in such a way as to keep substantially the same power consumption over time.

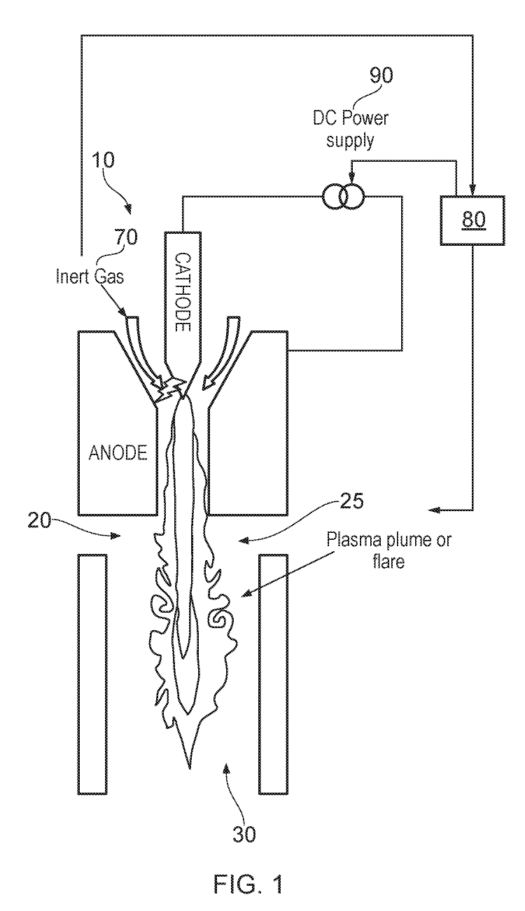

FIG. 1 shows a plasma torch 10 for use in the treatment of gas according to an embodiment. Plasma torch 10 has a cathode and an anode to which a power supply 90 supplies a substantially constant current. An inert source gas 70, flows between the cathode and the anode and the electric field between these electrodes causes an electrical discharge through the inert gas ionising the gas and forming a plasma plume. The core temperature of the plasma plume may be between 4,000-6,000° C.

A process gas 25 output from a processing chamber in, for example, a semi-conductor etching process is input and mixed with the plasma plume. In this embodiment a reagent gas 20 is also input and the gases and plasma pass through a mixing region 30 where the process gas 25, the reagent gas 20 and the plasma plume mix. The high temperature of the plasma plume cause chemicals within the process gas to be broken down to form other less harmful chemicals. In this way, an effluent process gas output from a process chamber can be treated to remove greenhouse and toxic gases.

In order for the process gas to be effectively treated and to reduce damage to the anode, the amount of reagent should be controlled to correspond to the amount required to react with the amount of process gas to be treated. Similarly the inert gas flow should be controlled to control both the power supplied by the power supply and to reduce excess dilution of the process gas.

Controller 80 controls the power output by power supply unit 90. Controller 80 receives signals from the power supply unit indicative of a current power that is being output. In this embodiment the power supply unit 90 is a DC constant current power supply unit and thus, the signals received by the controller are indicative of the current voltage being output. Variations in the output voltage are indicative of variations in the power output and the controller responds to these to maintain the power output by the power supply unit within predetermined limits. Thus, the controller determines when the voltage level rises above a predetermined value or falls below a different predetermined value and in response to this will generate control signals to vary the power output by the power supply unit and bring it back within predetermined limits.

In order to do this the controller 80 will initially determine whether the source gas flow rate can be varied to provide the required adjustment to the power output and where this is possible a control signal will be sent to the flow rate regulator to adjust it as required. Where this is not possible, then the constant current being output will be varied and the power output will be adjusted in this way.

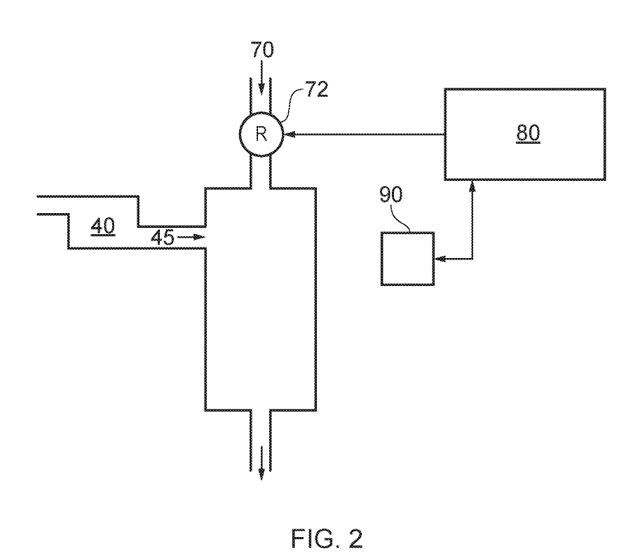

FIG. 2 shows an abatement system according to an embodiment of the present invention. The abatement system comprises a plasma torch 10 similar to that of FIG. 1, a power supply unit 90 that in this embodiment is a constant voltage power supply unit and controller 80 for controlling the power supply unit and the flow rate regulator 72, that controls the rate of flow of source gas 70 supplied to the plasma torch.

This implementation is particularly advantageous when an AC power supply unit is employed. In such a case, in lieu of voltage and current the root mean square values of these quantities are considered and the voltage root means square is changed along with the source gas flow to keep the power stable.

Process chamber 40 in a semiconductor manufacturing process supplies process gas 25 to the plasma torch for abatement. This is typically done using a vacuum pump (not shown here) which keeps the process chamber evacuated. Source gas is supplied via flow rate regulator 72. Controller 80 monitors the current output by power supply unit PSU 90 and the flow rate of the source gas and when the current indicates that the power output by the PSU is either falling below a predetermined threshold level or rising above a predetermined threshold level, controller 80 will determine whether the rate of flow of source gas is at or close to a maximum level, when the power threshold exceeded is a minimum one, or a minimum level when the power threshold exceeded is a maximum one. If it is not it will send a control signal to vary the rate of flow of source gas to bring the power level back within desired limits. If the rate of flow of source gas cannot be varied in this way without exceeding limit values, then the controller will output a control signal to vary the voltage level output by the PSU 90 and control the power level in this way.

If variations in the power level are such that the controller seeks to adjust the Voltage level beyond predetermined limit values, then a warning signal may be generated indicating that the anode should be inspected.

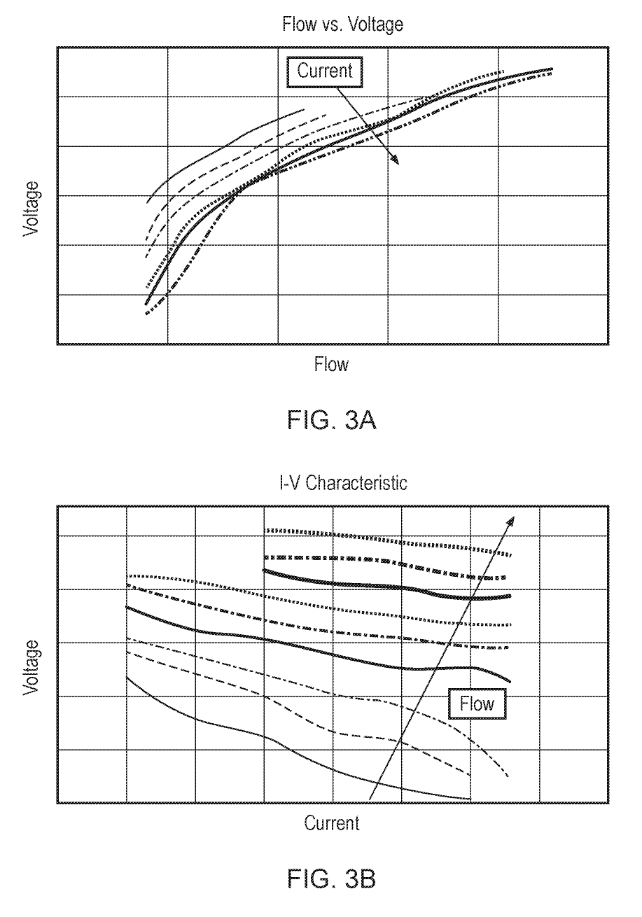

FIG. 3A schematically shows how voltage changes with the flow of source gas with different output currents. Thus, as the flow of source gas increases, the voltage required to maintain a current will also increase initially, plateauing out at a certain point, FIG. 3B shows a similar graph of how voltage changes with current for different rates of flow of source gas. As can be seen, as the source gas flow rate increases a higher voltage is required to generate the same current, while for the same flow of source gas as current increases the voltage drops. This aspect of the voltage dropping with increasing current makes the power supply to the plasma torch difficult to control by voltage and current alone which is why controlling changes in source gas flow can be an effective means of control.

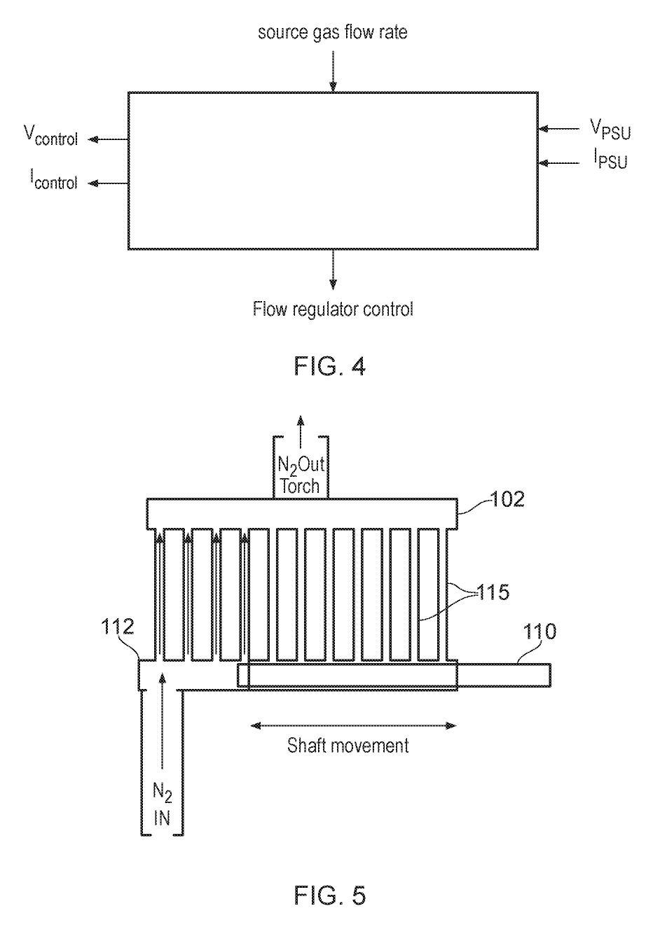

FIG. 4 schematically shows controller 80 of FIG. 2 in more detail. Controller 80 receives a number of input signals and outputs a number of control signals. In this embodiment, it receives input signals indicating the rate of flow of the inert source gas transmitted to the plasma torch and it also receives input signals from the power supply unit indicating the current level of current and voltage output by this unit.

The controller processes these input signals and from these generates and outputs control signals to control the rate of flow of source gas transmitted to the plasma torch and to control one of the voltage or current output by the power supply unit. In situations where control of the flow of source gas is not sufficient to control the power to within required limits, the controller will control the power output by the power supply unit by changing at least one of the voltage or current output. In this regard in the case of a constant current power supply as shown in FIG. 1 it will be the current that is varied to maintain the power within the required limits, while with the system shown in FIG. 2 it will be the voltage. When an AC power supply unit is used then it will be the root mean square value of the current and voltage that are monitored and/or changed.

FIG. 5 shows a flow regulator 102 for use in controlling the source gas flow rate. This flow regulator has the advantage of a simple yet effective design which allows changes in the source gas flow to be made in a proportional manner. The amount of flow is changed by moving an obstructing member 100 with a linear motion, which allows simple control by a stepper motor. Flow regulator 102 has an input tube for supplying a gas stream to an output tube via an input manifold 112, parallel flow tubes 115 and an output manifold 122. In this embodiment parallel flow tubes 115 each have the same diameter and thus, obstructing each one varies the flow rate in the same way. Control of the obstructing member 100 by a stepper motor (not shown), either opens or closes the parallel tubes 115 and thereby increases or decreases the flow area available to the gas flow. In this way, the flow can be varied in a simple and easily controllable manner with the closure of each tube reducing the flow by a proportional amount. Although in this embodiment the flow tubes have the same diameter allowing for simple proportional control, in some embodiments it may be that a flow regulator with different diameter tubes is used to provide different variations in the flow rate provided.

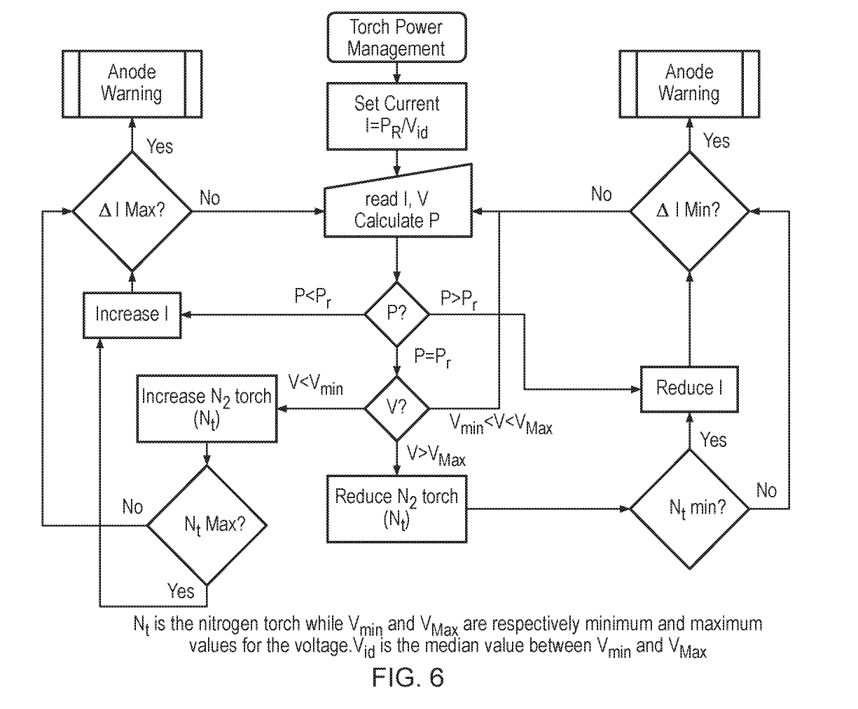

FIG. 6 shows a flow diagram illustrating steps in a method performed to control the power supplied by a constant current power supply unit to a plasma torch according to an embodiment. This method can be performed to compensate for changes in the anode due to anode erosion or powder deposition.

As can be seen in this flow diagram, where the torch power management system is set to on, then the current of the constant current power supply is set to a value that is dependent on the required power and on a median voltage. This median voltage is set between the minimum and maximum allowable voltages. The current and voltage being output by the power supply are continually monitored and it is determined if there are variations in the voltage required to produce this set current. If the voltage falls beneath a minimum value, then the nitrogen flow to the torch is increased to maintain the voltage above the minimum. If the voltage goes above a maximum, then the nitrogen flow to the torch is reduced to maintain the voltage at the correct value. However, there are minimum and maximum values of nitrogen flow that can be used to provide an effective plasma torch and if the minimum flow is reached, then in order to maintain the power at the required levels, the current output by the power unit is reduced avoiding the power consumed by the power supply unit rising unduly. In this way, the voltage and power levels are kept within required limits avoiding the power being output by the plasma torch gradually changing over time as anode erosion or powder deposition occur. Where powder deposition at the anode occurs then the voltage will fall and this can be compensated for by an increase in the flow of the source gas. This may be advantageous as this increase in gas flow rate may help to clear the powder from the anode.

At a certain point anode erosion or powder deposition may become so great that a required variation in the constant current output by the power supply unit will take it outside of predetermined limit values. It is therefore convenient if this system is used in conjunction with a warning system in which warning “anode inspection” signals are generated by the control logic when it determines that the current output by the constant current power supply has increased or reduced beyond a certain level, this level being selected at a point where efficient operation of the plasma torch and/or power supply unit may soon be compromised. Such warning signals indicate that the anode should be inspected and in some cases may soon require replacement or cleaning.

In the case that the power supply unit is a constant voltage power supply unit then a similar method is performed but the power is monitored by changes in the current and changes to the voltage are provided to change the power output when changes to the source gas flow rate are not appropriate. In such a case anode inspection signals may also be generated when the voltage level passes beyond certain limits.

In summary, a power control option is provided which will adjust the torch voltage and/or current which can change due to anode erosion and/or powder deposition in such a way as to keep substantially the same power consumption over time. This avoids or at least reduces changes in devices' power consumption over time and can be done in the first instance by adjusting the torch plasma source gas flow. When this reaches its interlock value, torch power can be changed by varying the constant voltage or current supplied. Laboratory tests have shown that within 20% of torch current variation, the same DRE (destruction or removal efficiency) is returned by the same power.

The anode voltage of a plasma torch supplied by a constant current power supply can progressively increase due to anode erosion or reduce during abatement due to the formation of solid deposition (due to the presence of powder) at the anode exit. Powder deposition may be particularly heavy during both CVD and metal etch, while it tends to be less of a problem when dealing with effluent from oxide, poly-silicon and deep-trench etch. In the case of powder deposition suitable control can progressively increase flow (hence voltage) and, after that, current to keep the power up, this can also remove the deposition providing “cleaning” of the anode.

This mechanism is the opposite to the voltage (N2 flow) reduction and current compensation due to power increment brought about by anode erosion.

To summarize the two dynamics for a constant current power supply unit supplying power to a plasma torch are the following:

Anode erosion->voltage increases->PLC reduces torch nitrogen->if not enough it reduces torch current->if still not enough it displays a warning message.

Anode deposition->voltage decreases->PLC increases torch nitrogen->if not enough it increases torch current->if still not enough it displays a warning (which can disappear if the remedial action of the control removes the blockage)

Furthermore, a flow regulator comprising a proportional flow tube instead of a proportional control valve such as is shown in FIG. 5 can be used to control the flowrate of the source gas. This device can provide a cheap and simple flow control system for use in the power (source gas control) and reagent control.

This DC-arc torch system is particularly effective in the Semi-Etch market which is currently dominated by a fixed single power DC-arc torch system. The semi-etch market requires high powers to break down stable greenhouse gases such as CF₄ and SF₆. The stability of these compounds mean the power requirements for their abatement are very high and thus, a system that can vary power depending on requirements can be highly advantageous. In summary, a tuneable power torch with an abatement system that is particularly applicable for both semi-conductor etch and FPD etch systems and provide flow tube gas control is provided.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A method of maintaining power output by a power supply configured to supply power to a plasma torch in a gas treatment system within a predetermined power limit, said method comprising:
periodically receiving at least one input signal indicative of a current power output by said power supply;
in response to said at least one input signal indicating said power output has passed a predetermined value adjusting said power output such that said power output is within said predetermined power limit;
said step of adjusting said power output comprising:
outputting a control signal to change a flow rate of a source gas supplied to said plasma torch where said change would maintain a source gas flow rate within predetermined gas flow limits; and
where said change would not maintain said source gas flow rate within said predetermined gas flow limits, outputting a control signal to change one of a current or voltage output by said power supply unit.

2. The method according to claim 1, wherein said power supply is configured to output a current and a voltage, one of said current and said voltage being output at a predetermined substantially constant value and the other of said current and voltage providing said at least one input signal; and wherein
said step of outputting said control signal to change said at least one of a current or voltage output by said power supply unit comprises outputting a control signal to change said predetermined substantially constant value to a different predetermined substantially constant value.

3. The method according to claim 2, wherein said power supply is configured to supply a predetermined substantially constant DC current, and said at least one input signal comprises a voltage output by said power supply.

4. The method according to claim 2, wherein said power supply comprises an AC power supply and said power supply is configured to output a predetermined substantially constant root mean square Voltage value.

5. The method according to claim 1, wherein said predetermined power limit comprises an upper power limit for said power supply, and in response to said at least one input signal indicating that said current power output is greater than a predetermined value, reducing said flow rate of said source gas where said flow rate is greater than a predetermined minimum value, and where not reducing said predetermined substantially constant value.

6. The method according to claim 1, wherein said predetermined power limit comprises a lower power limit for said power supply, and in response to said at least one input signal indicating that said current power output is less than said predetermined value, increasing said flow rate of said source gas where said flow rate is less than a predetermined maximum value and where not, increasing said predetermined substantially constant value.

7. The method according to claim 1, comprising maintaining said power output by said power supply within a predetermined range, said method comprising in response to said at least one input signal indicating said power output has passed one of an upper or a lower predetermined value, adjusting said power output such that said power output is within said predetermined power range.

8. The method according to claim 2, said method comprising a further step of in response to outputting said control signal to change said predetermined substantially constant value to beyond a predetermined limit value generating and outputting an anode inspection signal.

9. The method according to claim 1, comprising a further step of receiving a signal indicative of a current flow rate of a source gas supplied to said plasma torch; and
said step of adjusting said power comprises:
determining a required change in said source gas flow rate;
determining whether said required change to said source gas flow rate would bring said source gas flow rate outside of said predetermined gas flow rate limits; and
where said required change would not bring said source gas flow rate outside of said predetermined gas flow rate limits, outputting a control signal to a source gas flow regulator to make said required change; and
where said required change would bring said source gas flow rate outside of said predetermined gas flow rate limits, outputting a control signal to change said substantially predetermined value.

10. A computer program which when executed by a processor is operable to control said processor to perform steps in a method according to claim 1.

11. A controller for maintaining a power output by a power supply, configured to supply power to a plasma torch in a gas treatment system, within a predetermined power limit, said controller comprising:
an input configured to receive at least one input signal indicative of a current power output by said power supply;
logic configured to generate a control signal for controlling said output of said power supply, said logic being operable in response to said at least one input signal indicating said power output has passed a predetermined value to adjust said power output such that said power output is within said predetermined power limit, by:
generating a control signal to change a flow rate of a source gas supplied to said plasma torch rate where said change provides a source gas flow rate within predetermined gas flow limits; and
where said change provides a source gas flow rate that is not within predetermined gas flow limits, generating a control signal to change one of a current or voltage output by said power supply unit; and
an output for outputting said control signals.

12. The controller according to claim 11, wherein said logic comprises programmable control logic comprising a computer program.

13. The apparatus for treating a gas stream comprising:
a plasma torch for generating a plasma plume from a source gas when energised by electrical energy;
a power supply for supplying said electrical energy to said plasma torch;
a flow rate regulator for regulating a rate of flow of said plasma source gas to said plasma torch; and
a controller comprising:
an input configured to receive at least one input signal indicative of a current power output by said power supply;
logic configured to generate a control signal for controlling said output of said power supply, said logic being operable in response to said at least one input signal indicating said power output has passed a predetermined value to adjust said power output such that said power output is within said predetermined power limit, by:
generating a control signal to change the rate of flow of said plasma source gas to said plasma torch where said change provides a source gas flow rate within predetermined gas flow limits; and
where said change provides a source gas flow rate that is not within predetermined gas flow limits, generating a control signal to change one of a current or voltage output by said power supply unit; and
an output for outputting said control signals.

14-17. (canceled)
